(19) United States
(12) Patent Application Publication
(10) Pub. No.: US 2007/0093572 A1
(43) Pub. Date: Apr. 26, 2007

(54) White ink

(76) Inventor: Jayprakash Bhatt, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/254,522

(22) Filed: Oct. 20, 2005

(51) Int. Cl. C09D 11/00; C09D 5/00

(52) U.S. Cl. 523/160; 523/161

(57) ABSTRACT

White ink includes an ink vehicle and pigment particles suspended in the ink vehicle. When the ink is in a liquid state, the particles encapsulate a liquid, and after the liquid in the ink diffuses from the particles, the particles encapsulate air.

### BACKGROUND

Some formulations of white marking fluids (or inks) may be unsuitable for ink-jet printing applications. For example, some white inks include particles, e.g., inorganic pigments, such as titanium dioxide (TiO₂), calcium carbonate (CaCO₃), or the like that are suspended in a liquid ink carrier (or vehicle). Such particles have a relatively high specific gravity and often do not remain in suspension for the life of an ink cartridge. Organic latex polymers have lower specific gravities than TiO₂ or CaCO₃ and remain in suspension for a longer time. Organic latex polymers with glass transition temperature below room temperature coalesce to form a continuous film when dried. Ink made of such solid organic latex polymers upon drying do not scatter light or have hiding power and are therefore unsuitable as white ink in printing applications.

### DESCRIPTION OF THE DRAWINGS

FIG. 1 illustrates an embodiment of a marking fluid, according to an embodiment of the invention.

FIG. 2 illustrates an embodiment of a pigment particle of the marking fluid of FIG. 1, according to another embodiment of the invention.

FIG. 3 illustrates an embodiment of an ink cartridge, according to another embodiment of the invention.

FIG. 4 illustrates an embodiment of an ink deposition system, according to another embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

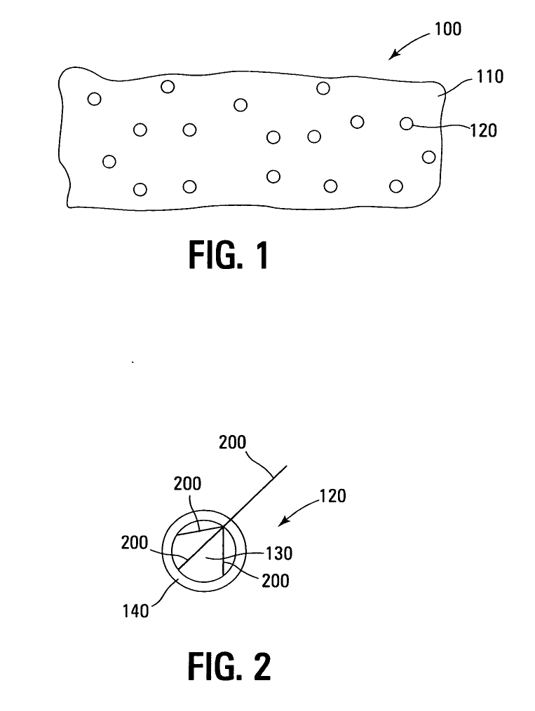

FIG. 1 illustrates a white marking fluid (or ink) 100, according to an embodiment. Ink 100 is suitable for ink-jet printing applications. Ink 100 includes organic pigment particles 120 suspended in a liquid ink carrier (or vehicle) 110. FIG. 2 illustrates an organic pigment particle 120, according to another embodiment. For one embodiment, organic pigment particles 120 are a non-film forming synthetic latex and do not coalesce with each other upon drying. For another embodiment, a glass transition temperature of organic pigment particles 120 is greater than about 10° C. to about 23° C. For another embodiment, organic pigment particle 120 may be spherical in shape and may be solid or hollow. For one embodiment, organic pigment particle 120 may be a synthetic styrene/acrylic co-polymer. For another embodiment, organic pigment particle 120 has a size of about 0.5 microns and a specific gravity of about 1.06. This specific gravity is such that pigment particles 120 remain suspended in ink-vehicle 110 for substantially the life of an ink cartridge or reservoir that contains ink 100. For one embodiment, pigment particle 120 is a ROPAQUE® HP-543P hollow-sphere pigment available from Rohm & Haas Company, Philadelphia, Pa., U.S.A.

For one embodiment, when pigment particle 120 is suspended in liquid ink vehicle 110, pigment particle 120 encapsulates a liquid, such as water, in a core 130. After ink 100 is deposited on a printable medium, such as paper, the water permanently diffuses from core 130 through a shell 140 of pigment particle 120 and is replaced by air. For another embodiment, such pigment particles have a glass transition temperature greater than about 100° C. Light 200 is scattered as it passes through shell 140 and into the air-containing core 130, as shown in FIG. 2. For one embodiment, pigment particles 120 are in the form of an aqueous suspension before they are dispersed in ink vehicle 110.

Ink vehicle 110 may be any liquid ink vehicle suitable for ink-jet printing. For example, ink vehicle 110 may include diethylene glycol, 1,2-hexanediol, glycerol, LEG-1, tergitol 15-S-7, Zonyle FSO, proxel GXL polymeric binder and deionized water. For this ink vehicle, an exemplary ink 100 may include 2 percent diethylene glycol, 4 percent 1,2-hexanediol, 5 percent glycerol, 5 percent LEG-1, 1 percent tergitol 15-S-7, 0.2 percent Zonyle FSO, 0.2 percent proxel GXL, about 1 to about 30 percent pigment particles 120, and the remainder deionized water, e.g., about 52.6 to about 81.6 percent, where the percentages are mass percentages.

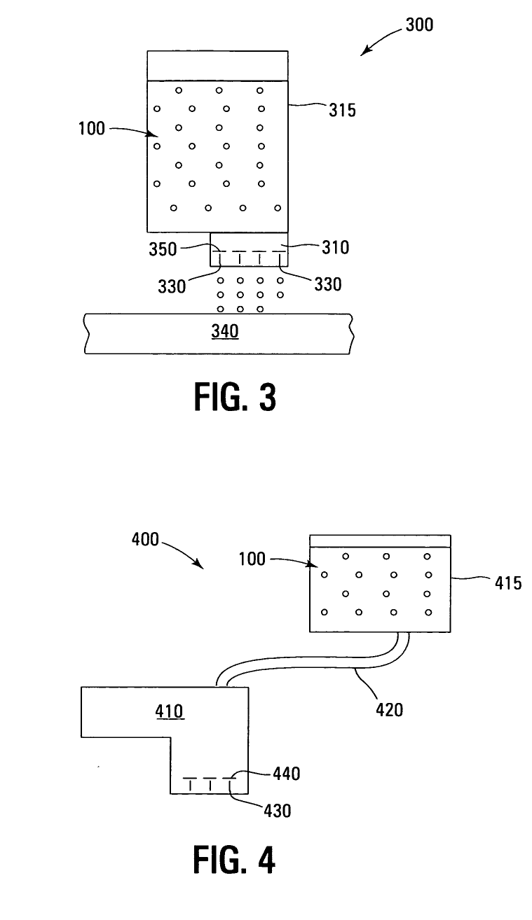

FIG. 3 illustrates an ink (or print) cartridge 300, according to another embodiment. Print cartridge 300 includes a print head 310, e.g., an ink-jet print head, that in one embodiment is integral with an ink reservoir 315. Print head 310 is fluidly coupled to ink reservoir 315. Ink reservoir 315 contains ink 100, as described above, and supplies ink 100 to print head 310 during printing. Print head 310 includes orifices 330 for ejecting droplets of ink 100 on a printable medium 340, e.g., paper, for printing when print cartridge 100 is carried over printable medium 340 by a movable carriage (not shown) of an imaging device (not shown), such as a printer. In another embodiment, ink 100 is expelled through orifices 330 by vaporizing the ink using resistors 350 located within print head 310.

FIG. 4 illustrates an ink deposition system 400, according to another embodiment. Ink deposition system 400 includes a print head 410, e.g., an ink-jet print head, fluidly coupled to an ink reservoir 415 by a flexible conduit 420, such as plastic or rubber tubing or the like. Ink reservoir 415 contains ink 100 and supplies ink 100 to print head 410 during printing via conduit 420. For one embodiment, print head 410 is attached to a movable carriage (not shown) of an imaging device (not shown), such as a printer, while ink reservoir 415 fixed to the imaging device remotely to print head 410. During printing, print head 410 moves across a printable medium, such as paper, to deposit images on the printable medium, while ink reservoir 415mains stationary. Flexible conduit 420 enables print head 410 to move relative to ink reservoir 415. Print head 410 includes orifices 430 for expelling ink 100 supplied to print head 410 for printing on the printable medium. In one embodiment, the ink 100 is expelled through orifices 430 by vaporizing the ink using resistors 440 located within print head 410.

For another embodiment, the resistors 350 of FIG. 3 and the resistors 440 of FIG. 4 may be replaced with actuators, such as piezoelectric actuators. For this embodiment, voltage pulses are applied to the piezoelectric actuators, causing them to expand. The expansion acts to eject ink 100 from the orifices 330 (FIG. 3) and orifices 440 (FIG. 4).

For other embodiments, ink 100 is pre-pressurized, e.g., reservoir 315 (FIG. 3) and reservoir 415 (FIG. 4) are pressurized, such as is commonly done for continuous inkjet (CIJ) printing, and is ejected under pressure though orifices 330 (FIG. 3) and orifices 440 (FIG. 4). For these embodiments, ink 100 is continuously supplied under pressure. For a non-ejecting state, ink 100 is blocked by a deflector (or gutter) (not shown), the use of which is well known in the art.

### CONCLUSION

Although specific embodiments have been illustrated and described herein it is manifestly intended that the scope of the claimed subject matter be limited only by the following claims and equivalents thereof.

What is claimed is:

1. A white ink comprising:
an ink vehicle; and
pigment particles suspended in the ink vehicle, wherein when the ink is in a liquid state the particles encapsulate a liquid and after the ink is deposited on a printable medium the particles encapsulate air.

2. The white ink of claim 1, wherein the pigment particles are copolymer of styrene and acrylic monomers.

3. The white ink of claim 1, wherein the pigment particles have a size of about 0.5 microns.

4. The white ink of claim 1, wherein the pigment particles constitute about 1 to about 30 percent of the white ink.

5. The white ink of claim 1, wherein the pigment particles have a specific gravity of about 1.06.

6. The white ink of claim 1, wherein the pigment particles are substantially spherical.

7. The white ink of claim 1, wherein the pigment particles are organic.

8. The white ink of claim 1, wherein when the ink is deposited on the printable medium, the pigment particles scatter light as the light passes through the pigment particles and into the encapsulated air.

9. The white ink of claim 1, wherein when the encapsulated liquid is water.

10. An ink-jet cartridge comprising:
a print head; and
an ink reservoir fluidly coupled to the print head, the ink reservoir containing white ink, the white ink comprising:
an ink vehicle; and
organic pigment particles suspended in the ink vehicle, wherein when the ink is in a liquid state the particles encapsulate a liquid and after the ink is deposited on a printable medium the particles encapsulate air.

11. The ink-jet cartridge of claim 10, wherein the organic pigment particles are copolymer of styrene/acrylic monomers.

12. The ink-jet cartridge of claim 10, wherein the organic pigment particles are substantially spherical.

13. The ink-jet cartridge of claim 10, wherein the organic pigment particles are non-film forming.

14. An ink deposition system comprising:
a print head;
an ink reservoir separated from the print head and fluidly coupled to the print head by a flexible conduit, the ink reservoir containing white ink, the white ink comprising:
an ink vehicle; and
organic pigment particles suspended in the ink vehicle, wherein the when the ink is in a liquid state the particles encapsulate a liquid and after the ink is deposited on a printable medium the particles encapsulate air.

15. The ink deposition system of claim 14, wherein the organic pigment particles are copolymer of styrene/acrylic monomers.

16. The ink deposition system of claim 14, wherein the organic pigment particles are non-film forming.

17. A method of printing, comprising:
depositing liquid white ink on a medium, wherein the white ink comprises organic pigment particles suspended in an ink vehicle, the pigment particles encapsulating a liquid; and
allowing the liquid from the white ink to diffuse from the organic pigment particles and allowing air to replace the liquid after depositing the white ink on the medium.

18. The method of claim 17, wherein disposing liquid white ink on a medium comprises ejecting droplets of the liquid white ink on the medium from an ink-jet print head.

19. The method of claim 17, wherein the organic pigment particles are non-film forming.

20. The method of claim 17, wherein the organic pigment particles are copolymer of styrene/acrylic monomers.

21. A method of forming white ink, comprising:
suspending a plurality of pigment particles in a liquid ink vehicle, wherein when the ink is in a liquid state, the particles encapsulate a liquid and after the liquid in the ink diffuses from the particles, the particles encapsulate air.

22. The method of claim 21, wherein the pigment particles are copolymer of styrene/acrylic monomers.

23. The method of claim 21, wherein the pigment particles have a size of about 0.5 microns.

24. The method of claim 21, wherein the pigment particles constitute about 1 to about 30 percent of the white ink.

25. The method of claim 21, wherein the ink vehicle is mostly water.

26. The method of claim 21, wherein the pigment particles have a specific gravity of about 1.06.

27. The method of claim 21, wherein the pigment particles are substantially spherical.

28. The method of claim 21, wherein the pigment particles are non-film forming.

29. The method of claim 21, wherein when the encapsulated liquid is water.

30. The method of claim 21, wherein the pigment particles are in an aqueous suspension prior to suspending them in the ink vehicle.
